(19) United States
(12) Patent Application Publication
(10) Pub. No.: US 2007/0287122 A1
(43) Pub. Date: Dec. 13, 2007

(54) Method for Treating Residual Caries

(75) Inventor: Steven D. Jensen, South Jordan, UT (US)

Correspondence Address: GEOFFREY E. DOBBIN, PATENT ATTORNEY, 4278 SOUTH 6220 WEST, WEST VALLEY CITY, UT, 84128-6501, US

(73) Assignee: CAO GROUP, INC., West Jordan, UT (US)

(21) Appl. No.: 11/759,784

(22) Filed: Jun. 7, 2007

Related U.S. Application Data
(63) Continuation-in-part of application No. 11/423,424, filed on Jun. 9, 2006.

(51) Int. Cl. A61C 3/02

(52) U.S. Cl. 433/29

(57) ABSTRACT

The present invention is a method of treating residual caries utilizing a matched laser and dye combination. After initial preparation and excavation of a caries site, a dye is flooded into the site which stains areas of residual caries. A laser with a complimentary wavelength is then used to ablate stained areas. Since healthy dental tissue will not receive the dye and allow staining, diseased tissue will be the only tissue that is stained, not only providing a visual indicator, but also providing a more efficient surface to receive laser energy and allow for more efficient ablation of the compromised tissue. According to the method, the dye may contain and enhancing, oxidizing compound or an anesthetic, and surrounding tissues may be protected by the use of substances opaque to the radiant energy. Indocyanine green has shown particular effectiveness as a dye in this and related methods.

### CROSS-REFERENCES TO RELATED APPLICATIONS

The present Application is a Continuing-in-part Application of prior filed U.S. application Ser. No. 11/423,424, filed Jun. 9, 2006, and incorporates the same by reference in its entirety.

### FIELD OF THE INVENTION

The present invention relates to the field of dental treatments and more particularly relates to a method of treating residual caries with a dye and matched laser.

### BACKGROUND OF THE INVENTION

Caries treatment in the prior art is a conceptually simple procedure—a practitioner, usually a dentist, excavates a caries site to remove diseased and decayed tissue and then refills the site with a substitute. Location of the site is usually a simple task as decay may either be visually or radio-graphically identified. Recently, excavation methods have utilized a laser to ablate the area and remove decayed tissue. While decayed tissue and bacterial waste usually leave a brownish or black coloration (resulting in easy absorption of laser energy), healthy hard tissue (i.e. tooth or bone) is usually white, causing a reflection of laser energy and a tendency to be more resistant to laser ablation that decayed tissue. Excavation usually stops when no more decayed tissue is visually detected; however, some compromised hard tissue and decay causing bacteria usually remains. Because of this fact, a practitioner usually excavates beyond what is visually detectable, without regard as to the health of this extra hard tissue as the practitioner has no idea as to how healthy the extra hard tissue is. This fact has led to the development of caries detectors—dyes used to quickly flush an excavated area, which are retained by more porous decayed dental tissue and therefore leave a more readily identifiable target for further excavation. Unfortunately, in order to remove this detected decayed tissue, a disproportionate amount of healthy surrounding hard tissue must also be removed. Some prior art has suggested using a photosensitizing material and allowing bacteria to absorb said material before then irradiating it with a laser as a means to sanitize the site, but this method is limited to surface effectiveness and cannot reach bacteria hidden in layers of diseased tissue. This does not address the problem of identifying and eliminating compromised and/or decayed residual hard tissue.

The present invention is a method using a laser to ablate tissue identified by a specific dye chosen to match the wavelength of the laser to increase effectiveness. The present invention represents a departure from the prior art in that the method of the present invention allows for total targeted ablation of carious areas not readily visible to the naked eye, while simultaneously utilizing innate resistance and reflective capability of healthy, hard tooth tissue to avoid unnecessary ablation.

### SUMMARY OF THE INVENTION

In view of the foregoing disadvantages inherent in the known methods of caries treatment, this invention provides a targeted method of caries treatment that more efficiently focuses on and destroys decayed and infected tissue. As such, the present invention's general purpose is to provide a new and improved method of caries treatment that is safe and effective to use, while being simultaneously efficient.

To accomplish these objectives, the method comprises selecting a dye which has an absorption spectrum complimentary with the wavelength of a user's laser. Using the laser, or some other means, to preliminarily excavate a caries site, then flushing the site with the dye to stain areas with residual caries. Finally, after excess dye has been removed by rinsing, using the laser to ablate stained areas and remove compromised tissue.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions in so far as they do not depart from the spirit and scope of the present invention.

### BRIEF DESCRIPTION OF THE DRAWINGS

FIGS. 1 through 17 are graphs of absorption spectra, depicting absorption intensity over light wavelength of sample stains, each figure and stain being listed below.

FIG. 1 is an absorption spectrum graph of amaranth.

FIG. 2 is an absorption spectrum graph of 8-anilinonaphthalene-1-sulfonic acid ammonium salt.

FIG. 3 is an absorption spectrum graph of bromophenol red (ph7).

FIG. 4 is an absorption spectrum graph of cresol red.

FIG. 5 is an absorption spectrum graph of 2,7 dichlorofluroescein.

FIG. 6 is an absorption spectrum graph of eosin 4-isothiocyanate.

FIG. 7 is an absorption spectrum graph of eosin Y.

FIG. 8 is an absorption spectrum graph of FD&C Blue #1.

FIG. 9 is an absorption spectrum graph of FD&C Green #3.

FIG. 10 is an absorption spectrum graph of FD&C Yellow #5 (Tartrazine).

FIG. 11 is an absorption spectrum graph of methylene blue.

FIG. 12 is an absorption spectrum graph of naphthol blue black.

FIG. 13 is an absorption spectrum graph of nigrosin.

FIG. 14 is an absorption spectrum graph of neutral red.

FIG. 15 is an absorption spectrum graph of safranine O.

FIG. 16 is an absorption spectrum graph of thymol blue.

FIG. 17 is an absorption spectrum graph of xylenol blue.

### DETAILED DESCRIPTION OF THE PREFERRED EMBODIMENT

With reference now to the drawings, the preferred embodiment of the method of residual caries treatment is herein described. It should be noted that the articles “a”, “an”, and “the”, as used in this specification, include plural referents unless the content clearly dictates otherwise.

A caries site is identified through known methods, which could include visual and physical inspection and/or radiographic identification, and prepped. An initial excavation is then performed, using the tools of a practitioner's choice (drills, lasers, sand-blasting, etc). Upon finishing the preliminary excavation, usually when no caries discoloration remains, the site is flushed with an identification dye (or “stain,” both terms being used interchangeably) which has an absorption spectrum that is complimentary with the practitioner's laser tool. By complimentary, this Application means that the absorption spectrum will have a peak at the emitted wavelength of the laser tool, at least proximately if not exactly. The nature of caries infection is such that bacteria decay and break down tooth enamel and dentin. The bacteria tend to burrow into these tissues, leaving them more porous than healthy hard tissue. The dye then permeates the diseased hard tissue through capillary attraction while leaving healthy hard tissue unaffected. After remaining dye is removed by rinsing, the laser is used to ablate the diseased and compromised tissue and remove it. The dye then not only serves as a visual guide for the practitioner, but also readily absorbs the laser energy and contributes to the ablation process. Healthy hard tissue will minimally absorb the dye and will actually exhibit a reflectance to the laser, in comparison to the compromised, dyed, tissue. This natural factor aids in targeting the tissue to be removed and avoiding healthy hard tissue. After the stained tissue is ablated, the practitioner will then etch the area with an acid etch to remove residual inorganic material. The acid etch is already a part of the prior art restoration procedure to prepare the site for an adhesive by removing smear layer. Ablation will remove all organic material and leave the remaining inorganic material in a structurally weakened state that is readily susceptible to the acid etching. In this method, the acid etch performs the described secondary duty of removing remaining mineral matrix. The practitioner may then repeat the process for further identification and elimination. After the practitioner is satisfied that the site has been properly excavated, the site is then re-filled with substitute material.

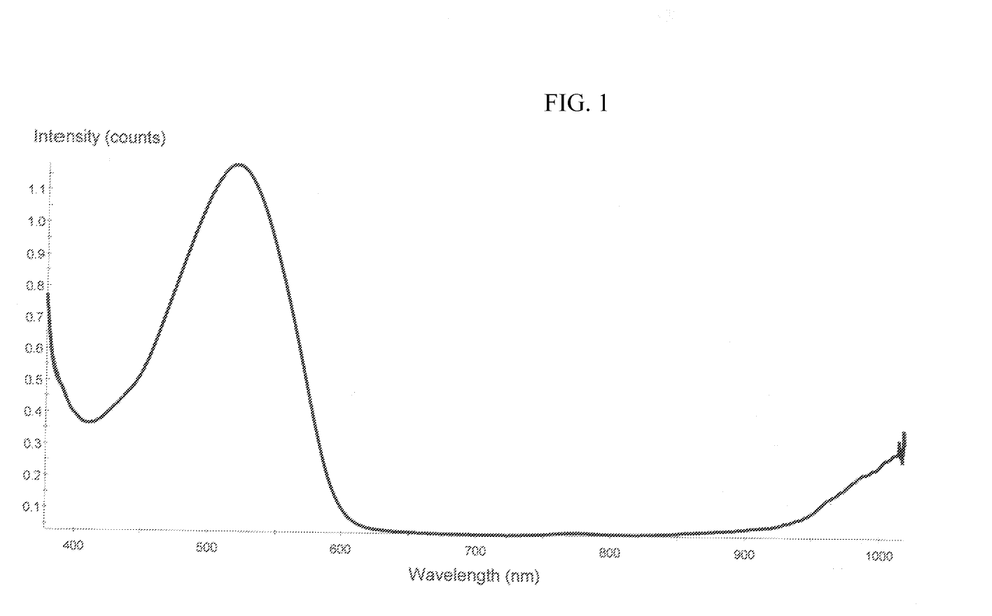

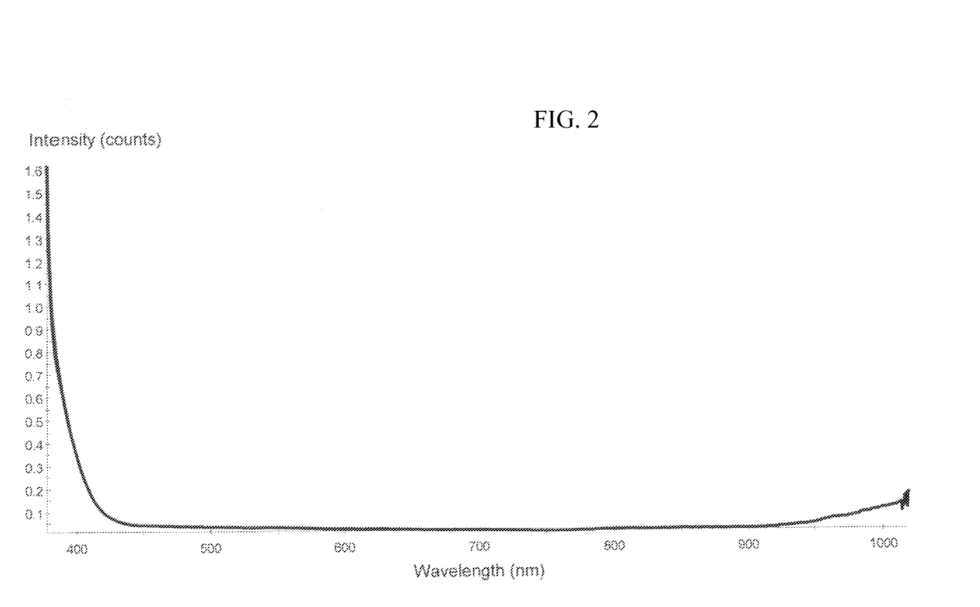

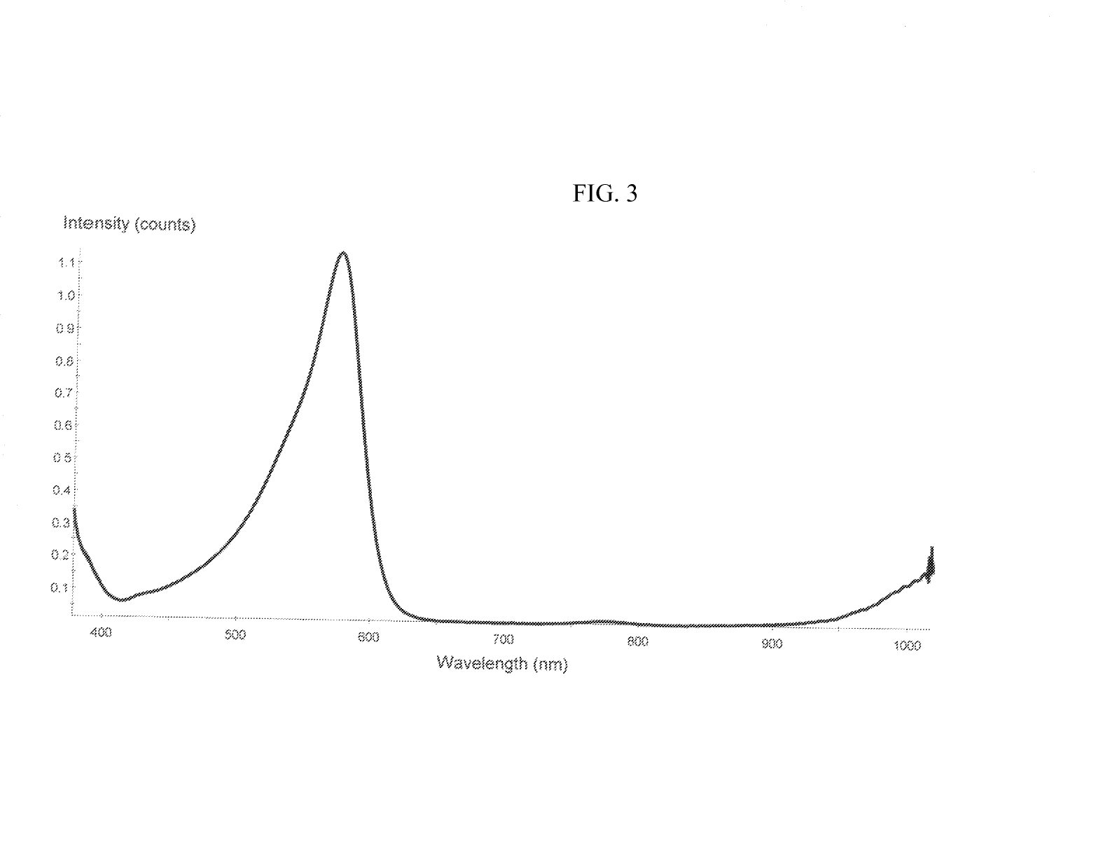

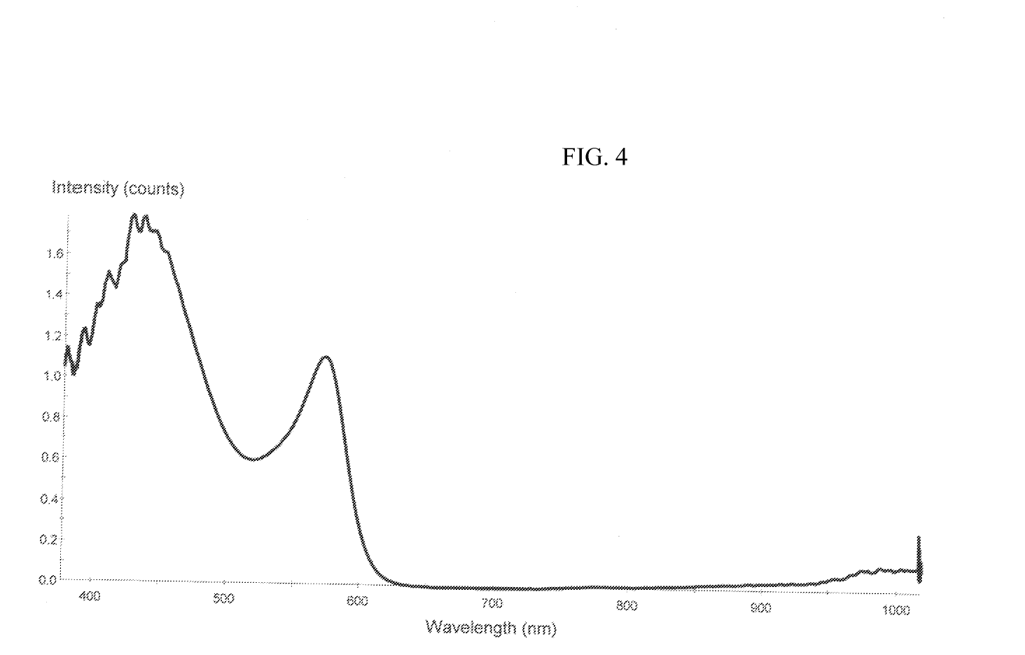

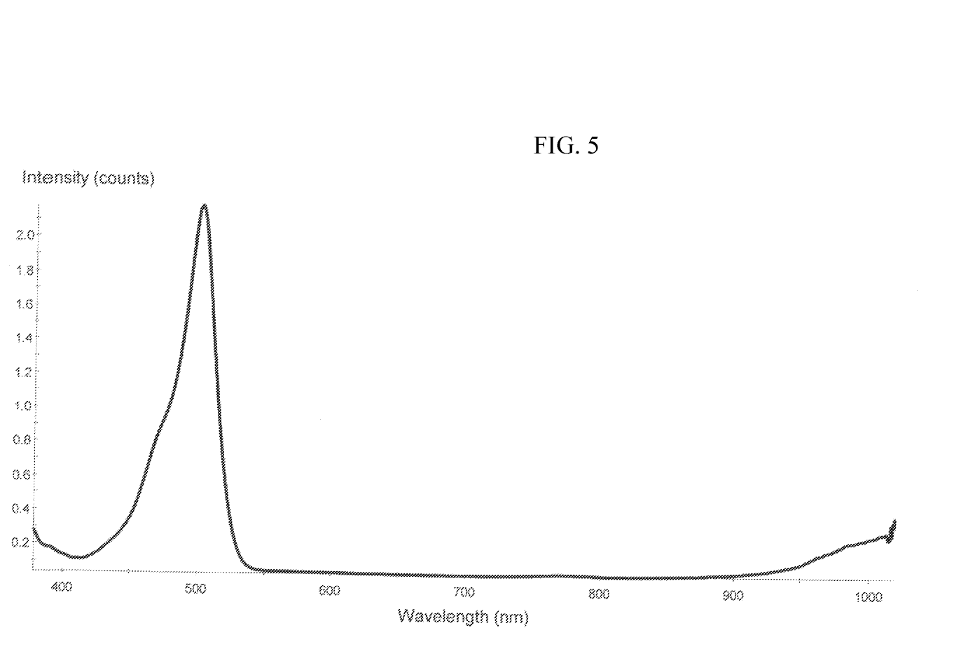

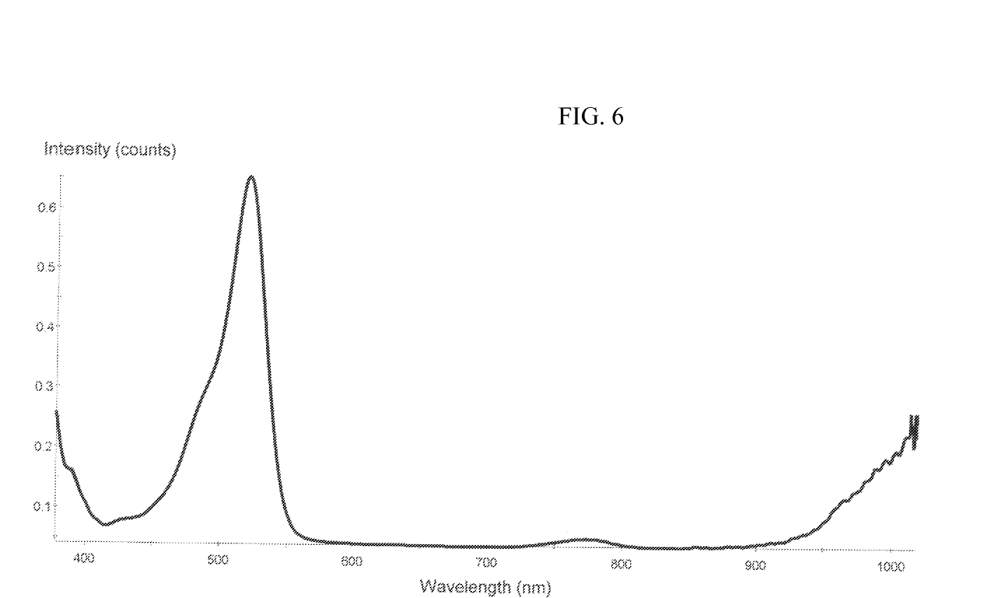

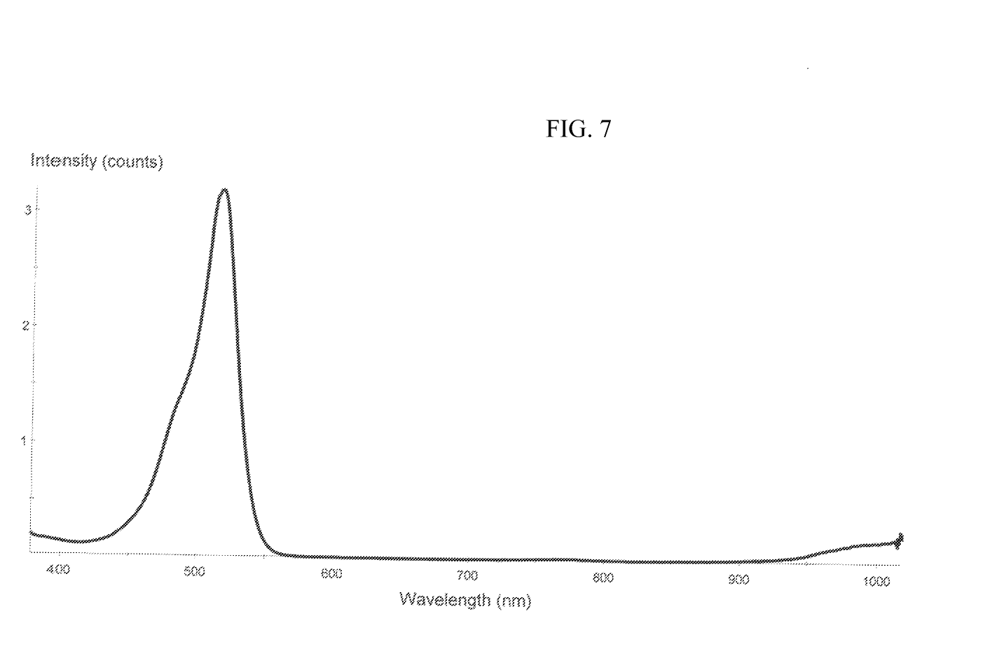

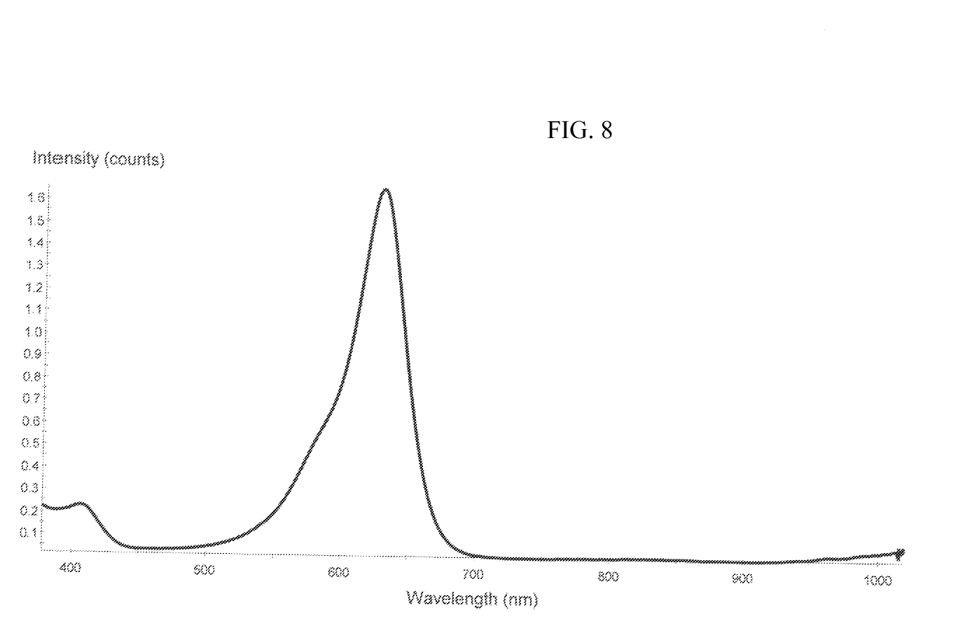

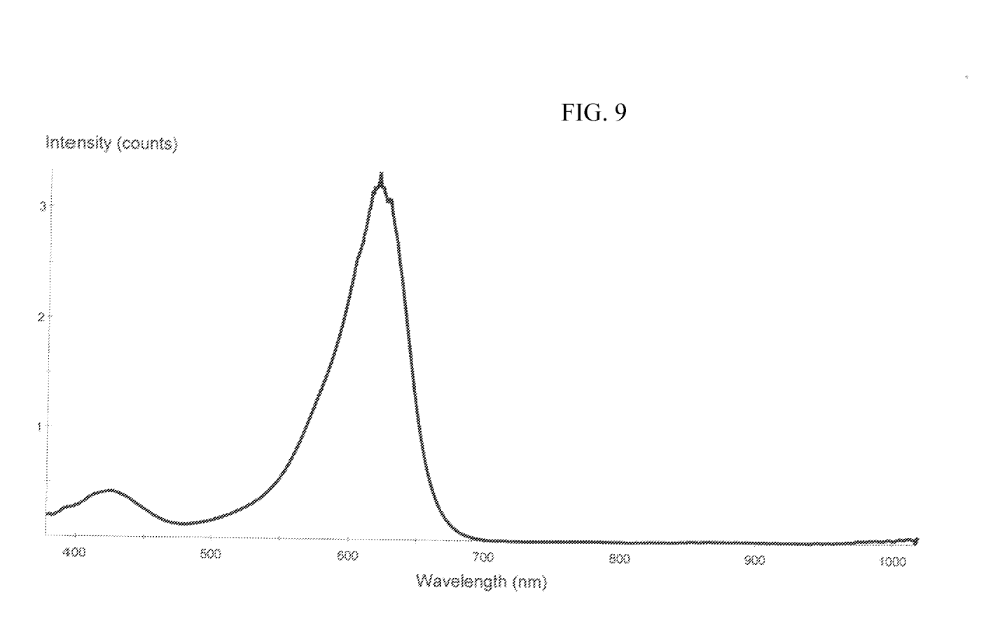

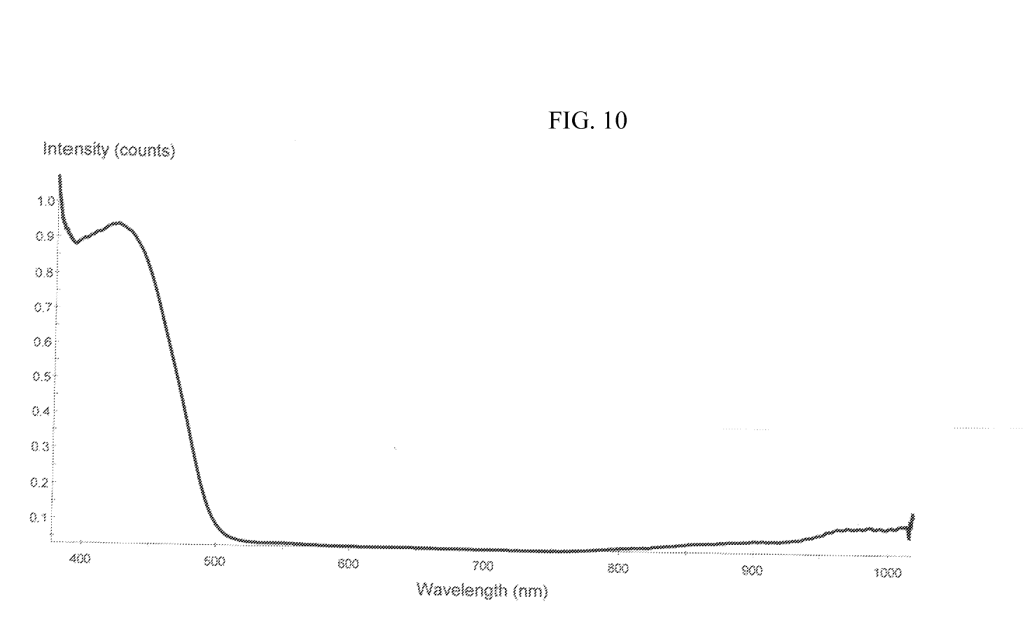

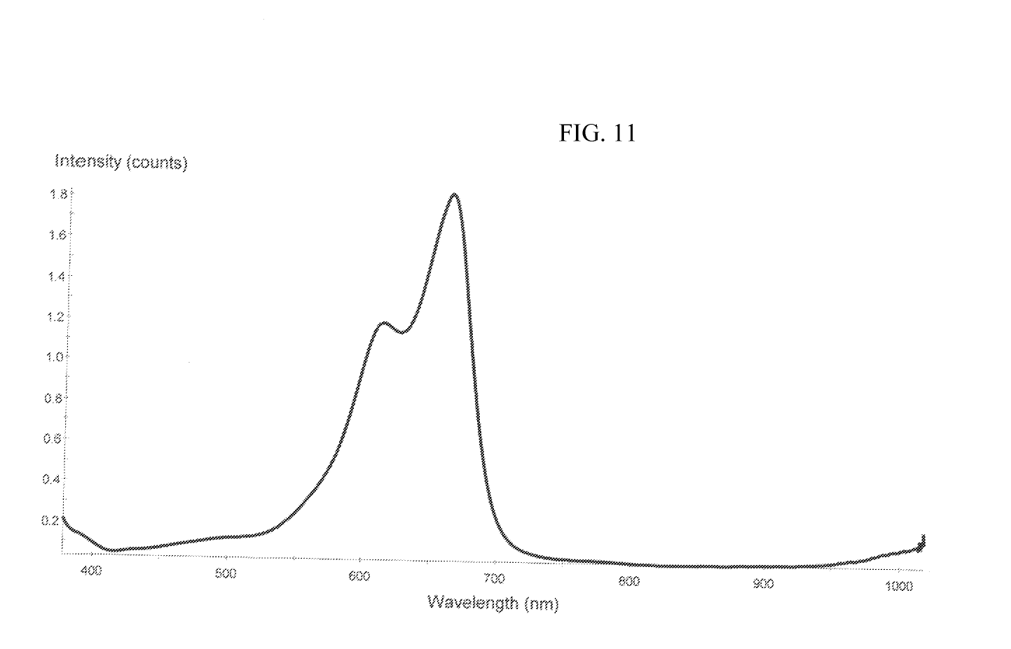

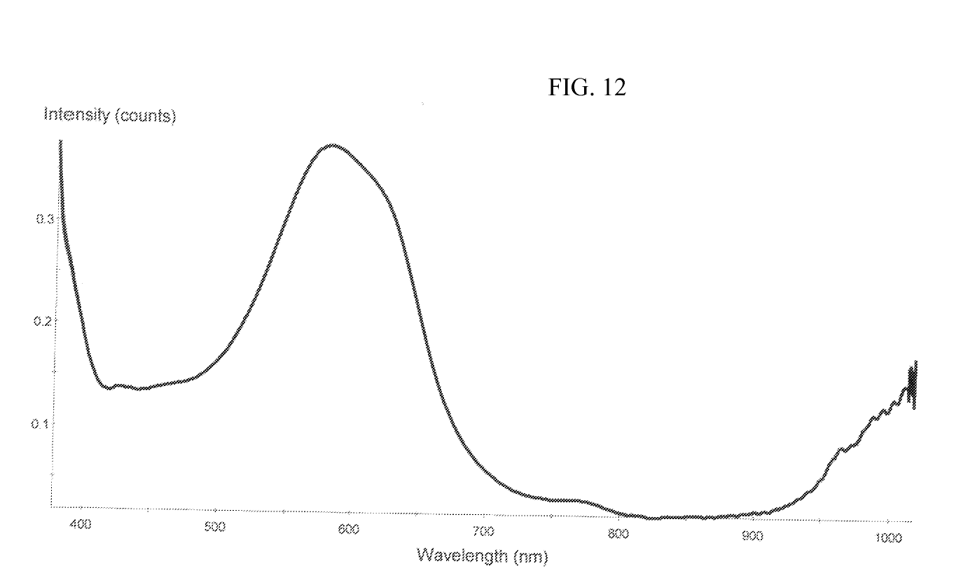

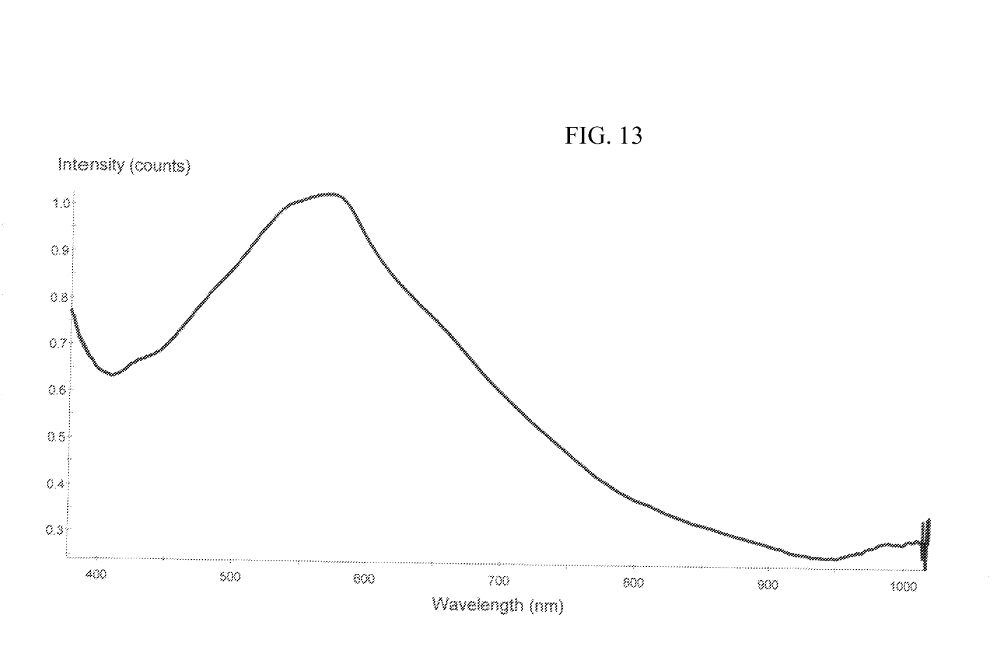

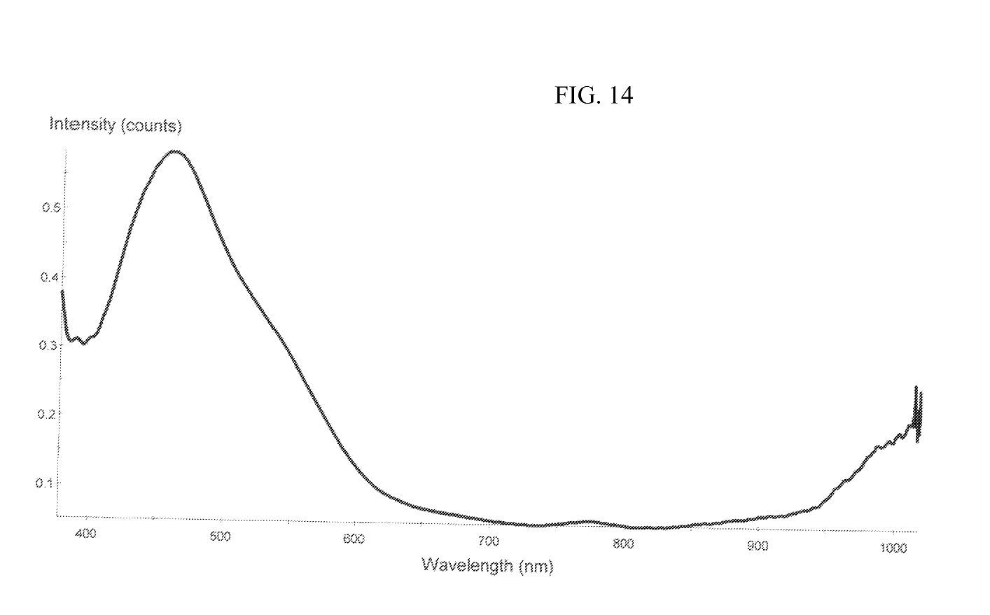

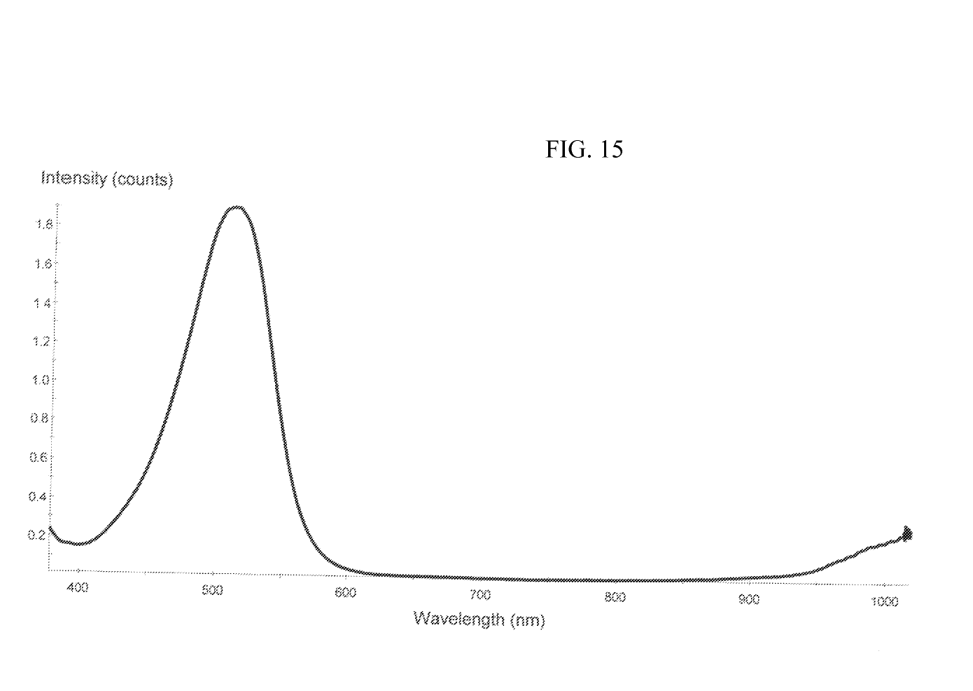

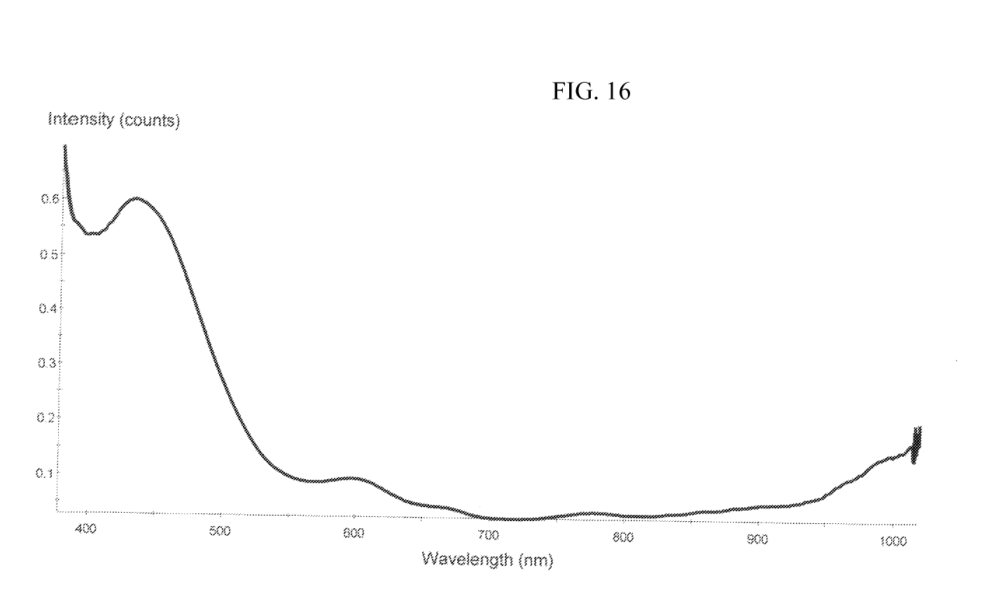

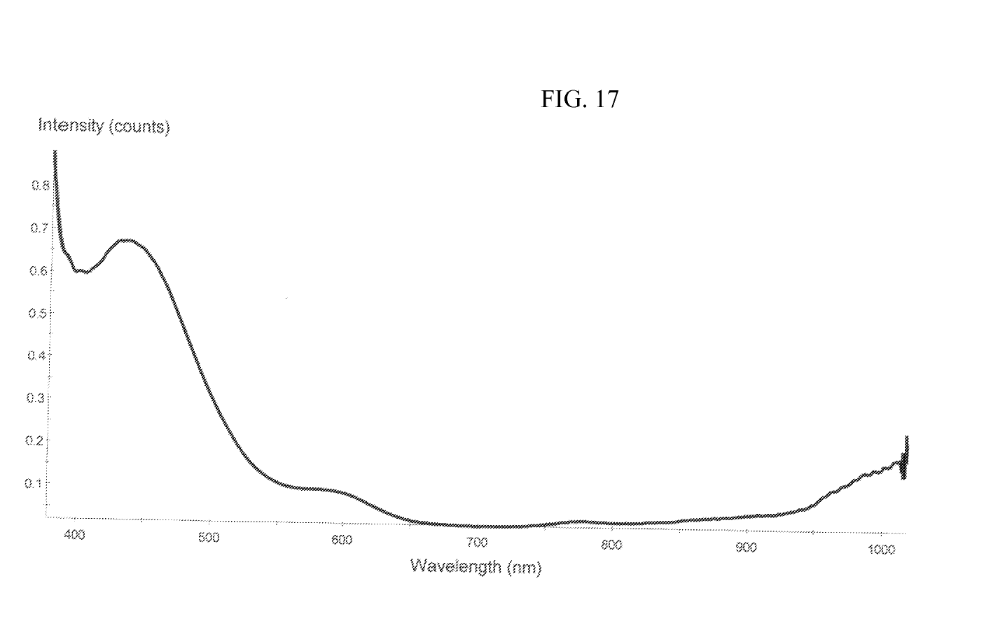

FIGS. 1-17 are examples of absorption spectra of various stains that could be used in the disclosed method. Comparing absorption spectra with the wavelength of a radiant energy source permits matching the source and stain for an efficient tissue cutting system and method. As shown in FIG. 1, the absorption spectrum for amaranth peaks at a wavelength of approximately 510 nm, the λ-max. Therefore, the use of a radiant energy source that has an energy output of 510 nm with the dye amaranth would be in accordance with the method herein disclosed. Likewise, FIGS. 2 through 17 are the spectra for sixteen other stains, each having at least one λ-max and each may be utilized with an energy source with an output having a wavelength corresponding to a given stain's λ-max. In a particular example of the practice of this method, it should be noted that diode lasers are capable of emitting energy with a wavelength of 810 nm. Indocyanine green, a particular stain that has been used extensively in other, unrelated, medical applications, has a λ-max of approximately 810 nm. The use of indocyanine green as an enhancing stain to aid in procedures where the practitioner uses a diode laser is firmly within the teachings of this method.

The method includes staining a selected tissue with a stain that is attuned to absorb the energy from a radiant energy source. The stain enhances absorption of incoming radiant energy, which results in increased destruction of stained tissues and the lessening of destruction of the column of tissues underneath and around the stained tissue. This method allows biological tissues to be destroyed by various strategies. Here, radiant energy can be concentrated to a degree as to totally annihilate a targeted biological tissue. The stain can be comprised of any substance with the ability to absorb or accept electromagnetic radiation from any radiant energy source. Radiant energy may be applied to an area from inside, arthroscopically, or outside the body.

There are literally thousands of dyes, stains and pigments that are commercially available and could be used with the disclosed methods. A few examples of such dyes stains and pigments that may be used individually or as an ingredient in a staining compound include, but are not limited to, are: carbon black, FD&C Blue #2, nigrosin, FD&C black shade, FD&C blue #1, methylene blue, FD&C blue #2, malachite green, D&C green #8, D&C green #6, D&C green #5, ethyl violet, methyl violet, FD&C green #3, FD&C red #3, FD&C red #40, D&C yellow #8, D&C yellow #10, D&C yellow #11, FD&C yellow #5, FD&C yellow #6, neutral red, safranine O, FD&C carmine, rhodamine G, napthol blue black, D&C orange #4, thymol blue, auramine O, D&C red #22, D&C red #6, xylenol blue, chrysoidine Y, D&C red #4, sudan black B, D&C violet #2, D&C red #33, cresol red, fluorescein, fluorescein isothiocyanate, bromophenol red, D&C red #28, D&C red #17, amaranth, methyl salicylate, eosin Y, lucifer yellow, thymol, dibutyl phthalate, indocyanine green, and the like. The preferred stain is one that is generally deemed biologically compatible or non-toxic and may include any of the above dyes, pigments and stains as an ingredient in a final solution used as a stain. Other stains, currently existing or discovered or manufactured in the future, may be readily utilized in this method. Therefore, the above listing should not be considered definitive, but rather illustrative of stains to be utilized in the disclosed method and in no way be considered limiting.

One method of applying the stains to biological tissues to be cut or destroyed can be performed by placement of either a powdered or a liquid form directly on the tissues. This can be done by spreading or smearing a dried powder with a flat instrument over the biological tissue to be treated. The soluble stains can be dissolved in a solvent such as water, glycerin, propylene glycol, mineral oil, ethanol, acetone, polysorbate 80, or any like solvent. These dissolved stains can be applied to biological tissues by means of a brush, a syringe, a pen, a cotton pellet, or any fibrous material. Some stains may be a liquid without being dissolved by a solvent; these may also be applied by means of a brush, a cotton pellet, a syringe, a pen, or any fibrous material. These stains may optionally contain an anesthetic such as lidocaine, benzocaine, or any local or systemic anesthetic that would aid in alleviating any pain or discomfort caused by the procedure. These stains can be formulated into various compositions to best fit a dental procedure, examples of which are presented below:

### EXAMPLE FORMULA #1

100% -nigrosin

### EXAMPLE FORMULA #2

1% -nigrosin

99% -water

### EXAMPLE FORMULA #3

100% -FD&C Blue #2

### EXAMPLE FORMULA #4

1.5% -FD&C Blue #2

98.5% -water

### EXAMPLE FORMULA #5

0.1% -FD&C Blue #2

30% -ethanol

69.9% -Water

### EXAMPLE FORMULA #6

1% -FD&C Green #3

30% -ethanol

0.5% -benzocaine

68.5% -Water

### EXAMPLE FORMULA #7

2% -Cresol red

98% -ethanol

### EXAMPLE FORMULA #8

0.5% -amaranth

10% -ethanol

89.5% -glycerol

### EXAMPLE FORMULA #9

100% Amaranth

### EXAMPLE FORMULA #10

1% -Eosin 4-isothiocyanate

25% -Polyethylene glycol 600

74% -ethanol

### EXAMPLE FORMULA #11

99% -Bromophenol Red

1% -Water

### EXAMPLE FORMULA #12

1.0% -FD&C Yellow #5

99% -Glycerol

### EXAMPLE FORMULA #13

3% -FD&C Blue #2

10% -polysorbate 80

87% -Water

### EXAMPLE FORMULA #14

5% -Indocyanine Green

95% -Water

The above example formulas are all able to adequately stain biological tissue.

The methods for cutting or destroying tissue warrant use of a radiant energy source with sufficient energy to destroy, carbonize or pyrolize biological tissue. The radiant energy can be produced from sources such as high intensity light from incandescent, halogen or plasma arc devices. The radiant energy can be produced from sources such as solid-state lasers, examples of which are neodymium YAG, titanium sapphire, thulium YAG, ytterbium YAG, Ruby, holmium YAG lasers and the like. The radiant energy can be produced from sources such as EB or electron beam devices. The radiant energy can be produced from sources such as gas lasers, examples of which are the Carbon dioxide laser, argon gas, xenon gas, nitrogen gas, helium-neon gas, carbon monoxide gas, hydrogen fluoride gas lasers, and the like. The radiant energy can be produced from sources such as a diode laser, examples of which are the gallium nitride, aluminum gallium arsenide diode laser and the like. There are also many dye lasers that utilize a radiant energy source that pass through various stains to achieve various wavelengths. Dye lasers are also within the scope of this method.

The method can include use of a radiant energy opaque substance that can be applied around the stained treatment area to protect against incidental or accidental exposure of harmful radiant energy during treatment. A typical procedure would begin by staining the area to be treated with a stain that is attuned to absorb the light from a radiant energy source, followed by covering the surrounding area with a substance that reflects or is opaque to the incoming radiant energy being produced. This combined procedure allows for targeted or selective destruction of biological tissues. The procedure allows the clinician to destroy or annihilate precisely the biological tissues selected and keep intact those tissues that are intended to remain.

A radiant energy opaque substance can be one that reflects most radiant energy and of a substance that is not combustible, for example, inorganic compounds that do not readily combine with atmospheric gases at elevated temperatures. Examples of radiant energy opaque substances are titanium dioxide, zinc oxide, calcium carbonate, and the like. Typically, radiant energy opaque substances are usually visibly white in color.

A method of applying the radiant energy opaque substance to biological tissues can be done by placement of the powdered form directly on the tissues. This can be done by spreading or smearing a dried powder with a flat instrument over the biological tissue to be treated. These substances can be blended in water to form a paste. These opaque suspensions can be applied to biological tissues by means of a brush, a flat instrument, a cotton pellet, a syringe, or any fibrous material. The paste can also contain a suspending aid to avoid settling of solids over time. Examples of suspending aids are sodium carboxy methylcellulose, fumed silica, sodium carboxy ethyl cellulose, precipitated silica, guar gum, and the like.

Radiant energy opaque substances can be formulated into various compositions to best fit a dental procedure, an example of which is presented below:

### EXAMPLE FORMULA #1b

50% -powdered titanium dioxide

1% -sodium carboxy methyl cellulose

49% -water

The above example formula would be recognized as adequately able to cover and protect biological tissue from incidental harmful radiant energy.

Another variation of this method is to apply an oxidizing substance to the targeted area before use of the laser. An oxidizing substance is any substance that releases oxygen upon decomposition. The substance decomposes and releases oxygen into the immediately surrounding environment, thereby enhancing the destruction of the targeted tissue. The substance may be applied in addition to the stain or may be a component ingredient of the stain if maintained in a stable form. Oxidizing substances may be organic or inorganic. Potential oxidizing substances that may be utilized in this method include: benzoyl peroxide, T-butyl peroxide, T-butyl peroxide benzoate, potassium nitrate, potassium nitrite, potassium chlorate, potassium chlorite, sodium nitrate, sodium nitrite, sodium chlorate, and sodium chlorite. It should be noted, however, that the use of certain stains, such as indocyanine green, may be so efficient as to render the addition of an oxidizing substance superfluous.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A method for treating residual caries after initial excavation is completed, said excavation leaving an excavated site, the method comprising:
a. flooding the site with a stain chosen to readily absorb energy emitted from a chosen laser source;
b. allowing some of the stain to be absorbed into compromised hard dental tissue;
c. rinsing the area, leaving the absorbed stain in the compromised hard dental tissue; and
d. ablating the compromised hard dental tissue with the laser until compromised organic tissue is removed and remaining inorganic tissue is prepared for removal by acid etch.

2. The method of claim 1 being repeated at least once.

3. The method of claim 1, the stain containing at least one ingredient selected from the group of ingredients consisting of: carbon black, FD&C Blue #2, nigrosin, FD&C black shade, FD&C blue #1, methylene blue, FD&C blue #2, malachite green, D&C green #8, D&C green #6, D&C green #5, ethyl violet, methyl violet, FD&C green #3, FD&C red #3, FD&C red #40, D&C yellow #8, D&C yellow #10, D&C yellow #11, FD&C yellow #5, FD&C yellow #6, neutral red, safranine O, FD&C carmine, rhodamine G, napthol blue black, D&C orange #4, thymol blue, auramine O, D&C red #22, D&C red #6, xylenol blue, chrysoidine Y, D&C red #4, sudan black B, D&C violet #2, D&C red #33, cresol red, fluorescein, fluorescein isothiocyanate, bromophenol red, D&C red #28, D&C red #17, amaranth, methyl salicylate, eosin Y, lucifer yellow, thymol, and dibutyl phthalate.

4. The method of claim 3, the stain further comprising an anesthetic.

5. The method of claim 1, the stain being applied to the excavated site by spreading a paste containing the stain over the excavated site.

6. The method of claim 5, the stain further comprising an anesthetic.

7. The method of claim 1, the stain being applied to the excavated site by spreading a liquid containing the stain over the excavated site.

8. The method of claim 7, the stain further comprising an anesthetic.

9. The method of claim 1, the stain being applied to the excavated site by spreading a powder containing the stain over the excavated site.

10. The method of claim 9, the stain further comprising an anesthetic.

11. The method of claim 1, further comprising the step of adding an oxidizing substance to the biological substrate.

12. The method of claim 11, the oxidizing substance being applied as a part of the stain.

13. The method of claim 11, the oxidizing substance being selected from the set of oxidizing substances consisting of: benzoyl peroxide, T-butyl peroxide, T-butyl peroxide benzoate, potassium nitrate, potassium nitrite, potassium chlorate, potassium chlorite, sodium nitrate, sodium nitrite, sodium chlorate, and sodium chlorite.

14. The method of claim 1, further comprising a step of applying a radiant opaque substance to tissues surrounding the biological substrate, wherein said surrounding tissues are then protected from absorbing energy from the radiant source.

15. The method of claim 14, the stain containing at least one ingredient selected from the group of ingredients consisting of: carbon black, FD&C Blue #2, nigrosin, FD&C black shade, FD&C blue #1, methylene blue, FD&C blue #2, malachite green, D&C green #8, D&C green #6, D&C green #5, ethyl violet, methyl violet, FD&C green #3, FD&C red #3, FD&C red #40, D&C yellow #8, D&C yellow #10, D&C yellow #11, FD&C yellow #5, FD&C yellow #6, neutral red, safranine O, FD&C carmine, rhodamine G, napthol blue black, D&C orange #4, thymol blue, auramine O, D&C red #22, D&C red #6, xylenol blue, chrysoidine Y, D&C red #4, sudan black B, D&C violet #2, D&C red #33, cresol red, fluorescein, fluorescein isothiocyanate, bromophenol red, D&C red #28, D&C red #17, amaranth, methyl salicylate, eosin Y, lucifer yellow, thymol, and dibutyl phthalate.

16. The method of claim 14, the stain being applied to the excavated site by spreading a paste containing the stain over the excavated site.

17. The method of claim 16, the stain further comprising an anesthetic.

18. The method of claim 14, the stain being applied to the excavated site by spreading a liquid containing the stain over the excavated site.

19. The method of claim 18, the stain further comprising an anesthetic.

20. The method of claim 14, the stain being applied to the excavated site by spreading a powder containing the stain over the excavated site.

21. The method of claim 24, the stain further comprising an anesthetic.

22. The method of claim 14, the stain further comprising an anesthetic.

23. The method of claim 14, the radiant opaque substance containing at least one ingredient selected from the group of ingredients consisting of: titanium dioxide, zinc oxide, and calcium carbonate.

24. The method of claim 14, further comprising the step of adding an oxidizing substance to the biological substrate.

25. The method of claim 24, the oxidizing substance being applied as a part of the stain.

26. The method of claim 24, the oxidizing substance being selected from the set of oxidizing substances consisting of: benzoyl peroxide, T-butyl peroxide, T-butyl peroxide benzoate, potassium nitrate, potassium nitrite, potassium chlorate, potassium chlorite, sodium nitrate, sodium nitrite, sodium chlorate, and sodium chlorite.

27. The method of claim 1, further comprising the step of using an acid etch to remove residual inorganic material after ablation.

28. A method for treating residual caries after initial excavation is completed, said excavation leaving an excavated site, the method comprising:
a. flooding the site with a stain containing indocyanine green;
b. allowing some of the stain to be absorbed into compromised hard dental tissue;
c. rinsing the area, leaving the absorbed stain in the compromised hard dental tissue; and
d. ablating the compromised hard dental tissue with the laser until compromised organic tissue is removed and remaining inorganic tissue is prepared for removal by acid etch.

29. The method of claim 28, the stain further comprising an anesthetic.
